(19) United States
(12) Patent Application Publication
(10) Pub. No.: US 2024/0159603 A1
(43) Pub. Date: May 16, 2024

(54) SENSOR HEAD FOR LOAD MEASURING DEVICE WITH MAGNETIC COILS

(71) Applicant: Trafag AG, Bubikon (CH)

(72) Inventor: Tobias ETTENAUER, Ostfildern (DE)

(21) Appl. No.: 18/505,312

(22) Filed: Nov. 9, 2023

(30) Foreign Application Priority Data
Nov. 11, 2022 (DE) 10 2022 129 926.0

(51) Int. Cl. G01L 1/12

(52) U.S. Cl. CPC G01L 1/12

(57) ABSTRACT

A sensor head includes a magnetic field generating unit for generating a magnetic field in the test object and a magnetic field measuring unit for measuring a magnetic field change in the test object. The magnetic field generating unit includes at least one excitation coil having a plurality of excitation coil windings arranged around an excitation coil axis, and the magnetic field measuring unit includes a measuring coil arrangement having a plurality of measuring coils. The radially outermost excitation coil winding is arranged radially outside the measuring coil arrangement, as viewed with respect to the excitation coil axis, so that the measuring coil arrangement is surrounded by at least the radially outermost excitation coil winding, as viewed in axial plan view of the sensor head.

### CROSS-REFERENCE TO RELATED APPLICATION(S)

This application claims priority from German Application No. 10 2022 129 926.0 filed Nov. 11, 2022, which is incorporated herein by reference in its entirety.

### TECHNICAL FILED

The invention relates to a sensor head for a load measuring device for measuring a load in a test object based on load-dependent magnetic properties of the test object. The invention further relates to a load measuring device comprising such a sensor head, and to a load measuring arrangement additionally comprising the test object.

In particular, the invention relates to a sensor head and a device and arrangement for measuring a mechanical load on a test object. In this context, loads are understood to be forces, torques or mechanical stresses on the test object.

### RELATED ART

Some embodiments of the invention relate in particular to a torque measuring arrangement with a torque transducer (example of a sensor head) for a torque sensor for measuring a torque on a rotating test object, in particular in the form of a shaft, while detecting magnetic field changes. In particular, the torque transducer, the torque sensor and the measuring method are designed for the detection of magnetic field changes due to the Villari effect, and more particularly for the magnetoelastic (=inverse magnetorestrictive) detection of torques.

Such load measuring sensors like force sensors or torque sensors, which detect loads like in particular forces or torques in test objects like shafts due to magnetic field changes, as well as the scientific basics for this are described in the following literature:
[1] Fleming, W. J., Engine Sensors: State of the Art, SAE Congress, Detroit, M Z, 1982 Paper 820904 97-113.
[2] Gerhard Hinz and Heinz Voigt “Magnoelastic Sensors” in “Sensors”, VCH Verlagsgesellschaft mbH, 1989, pages 97-152.
[3] U.S. Pat. No. 3,311,818
[4] EP 0 384 042 A2
[5] DE 30 31 997 A
[6] U.S. Pat. No. 3,011,340 A
[7] U.S. Pat. No. 4,135,391 A
[8] WO 2020/039013 A1
[9] DE 10 2018 113 378 A1
[10] EP 3 051 265 A1
[11] WO 2018/019859 A1
[12] WO 2019/197500 A1

In particular, a design of torque transducers as described in [4] (DE 30 31 997 A1) has been found to be particularly effective for measuring torques in shafts and other measuring points.

It is known that magnetic measuring methods can be used to determine the physical measurands torque, force and position on ferromagnetic objects. Magnetoelastic (or inverse-magnetostrictive) sensors or eddy current sensors are usually employed. The ferromagnetic materials used change their permeability under the influence of tensile or compressive stresses (also called Villari effect). In practice, it is usually difficult to distinguish between the individual effects. Only the eddy current sensor is easier to distinguish from the other effects due to its frequency dependence. In addition, the state of magnetization of the object is often not known or is permanently influenced by processing and handling of the objects, so that a broad industrial application is often difficult. Furthermore, a prediction of the lifetime of the magnetized objects is frequently not possible under the often quite harsh environmental conditions in which the technology is used (for example, but not exclusively, vehicles, chassis components, electromobility, such as e-bikes in particular, e.g. pedelecs, heavy industry, gearboxes, hydraulic systems in construction machinery or in agricultural machinery, and many more).

From literature [10] it is known to compensate this disadvantage by an active magnetization by means of a magnetic alternating field in the kHz range. For this purpose, generator and detector coils, hereinafter referred to as excitation coils and measuring coils, namely two first measuring coils A1, A2 and two second measuring coils B1, B2 as magnetic field detection coils and a central generator coil or excitation coil Lg in a cross arrangement (X arrangement) are used. In this case, the difference of the coil pair A−B=(A1+A2)−(B1+B2) is determined in an analog signal processing scheme.

From [11] and [12], a corresponding load measuring device with sensor head is known, in which several layers of planar coils for forming generator coils and measuring coils are accommodated in a sensor package.

In addition to temperature variations, measuring signals of the known load measuring devices with such sensor heads are also influenced by changes in the distance to the test object. In the case of shafts, even minor deviations of the shaft surface from the ideal round shape can have influences on the measurement, which is why efforts are made in some of the above-mentioned literature to correct such errors, e.g. by arranging the load measuring device around the shaft.

### SUMMARY

The invention is based on the problem of creating a sensor head with which a lower distance dependence can be achieved.

To solve this problem, the invention creates a sensor head according to claim 1. A load measuring device and a load measuring arrangement comprising such a sensor head are stated in the further independent claims.

Advantageous designs are the subject of the subclaims.

The invention provides a sensor head for a load measuring device for measuring a load in a test object based on load-dependent magnetic properties of the test object, the sensor head comprising a magnetic field generating unit for generating a magnetic field in the test object and a magnetic field measuring unit for measuring a magnetic field change in the test object, wherein the magnetic field generating unit comprises at least one excitation coil which has a plurality of excitation coil windings arranged around an excitation coil axis, and the magnetic field measuring unit comprises a measuring coil arrangement having a plurality of measuring coils, wherein the radially outermost excitation coil winding, as viewed with respect to the excitation coil axis, is arranged radially outside the measuring coil arrangement, so that the measuring coil arrangement, as viewed in axial plan view of the sensor head, is surrounded at least by the radially outermost excitation coil winding.

It is preferred that the measuring coil arrangement comprises a first to fourth measuring coil. It is preferred that the measuring coil arrangement comprises measuring coils arranged at the corners of an imaginary rectangle or square.

It is preferred that the measuring coils and/or the at least one excitation coil comprise at least one planar coil or are formed as at least one such planar coil.

In some embodiments, it is provided that the measuring coil arrangement is disposed radially within all excitation coil windings of the magnetic field generating unit.

In some embodiments, it is provided that the magnetic field generating unit has at least one outer excitation coil winding extending radially outwardly of the measuring coil arrangement as well as at least one inner excitation coil winding extending radially inwardly of the measuring coil arrangement.

In some embodiments, it is provided that the at least one excitation coil overlaps the measuring coil arrangement.

In some embodiments, it is provided that an outer excitation coil is disposed radially outside the measuring coil arrangement and an inner excitation coil is disposed radially inside the measuring coil arrangement.

In some embodiments, it is provided that the orientation of the at least one outer excitation coil winding is opposite to the orientation of the at least one inner excitation coil winding.

It is preferred that a magnetic field conductor is provided on a side of the coil arrangement formed by the at least one excitation coil and the measuring coil arrangement to be turned away from the test object.

In some embodiments, it is provided that the magnetic field conductor pierces the inner diameter of at least one coil of the coil arrangement.

It is preferred that the magnetic field conductor covers the side of the coil arrangement to be turned away from the test object.

It is preferred that the magnetic field conductor has a diameter larger than the diameter of the coil arrangement.

It is preferred that the magnetic field conductor is designed in such a way that—when used as intended—it protrudes in a region radially outside the coil arrangement in the direction of the test object.

It is preferred that the magnetic field conductor has an annular region, such as a collar, arranged around the coil arrangement. The annular region may be formed closed all around or may have apertures so that some protrusions are formed to influence or concentrate the magnetic flux as required.

It is preferred that the magnetic field conductor has one or more through holes, such as holes or recesses, for passing through coil terminals.

It is preferred that a non-magnetic electrical conductor surrounds the coil arrangement or the coil arrangement and the magnetic field conductor.

According to a further aspect, the invention provides a load measuring device for measuring a load in a test object, comprising a sensor head according to any one of the preceding embodiments, a current source connected to the at least one excitation coil for supplying the magnetic field generating unit with a periodically changing current, and an evaluation device connected to the measuring coils for generating a measuring signal from signals of the measuring coils.

The current source is preferably a high-frequency current source with frequencies of 10 kHz or higher in order to achieve a very good effect of the coils even without a flux amplifier core. The evaluation device is preferably designed in the manner known from [10] to generate a measuring signal from the outputs of the first to fourth measuring coils.

According to a further aspect of the invention, a load measuring arrangement comprises such a load measuring device and the test object.

Embodiments of the invention relate to a coil arrangement for distance-stable load measurements.

Some embodiments of the sensor head form a measuring transducer for load measuring having magnetic field generating windings and measuring transducer windings. The magnetic field generating windings together form one or more magnetic field generating coils (=excitation coils), preferably arranged concentrically to each other. The measuring transducer windings are arranged and connected in such a way that several measuring transducer coils (measuring coils for short) are formed. In particular, a first to fourth measuring coil (four poles) are formed which interact in pairs, with the pairs being arranged in a cross arrangement.

Some embodiments of the sensor head, the load measuring device and the load measuring arrangement are designed like the magnetic sensors of literature [1] but preferably without magnetic field conductors (in particular without an inner flux amplification core), in particular for measuring force and torque, on a magnetic inductive principle, and constructed in such a way that the magnetic field pickup coils are enclosed by the outermost winding of the or at least one magnetic field generating coil. The arrangement has the advantage that, compared to load measuring arrangements according to [1], the sensitivity to distance changes is low due to the large outer diameter of the magnetic field generating coil.

In some embodiments of the invention, the magnetic field generating windings include windings that extend outside the sensing coils as well as windings that extend inside the sensing coils.

In some embodiments, the pickup coils are overlapped by the excitation coil. For example, the excitation coil includes at least one planar coil disposed on a different axial plane than measuring transducer windings of the measuring coils. Also, the coils may have multiple planar coil layers that radially overlap each other. The planar coil layers forming the measuring coils (hereinafter referred to as measuring coil layers) and the planar coil layers forming the at least one excitation coil (hereinafter referred to as excitation coil layers) may each have multiple layers of, in particular, spirally formed planar coils or planar coil windings. Several measuring coil layers and several excitation coil layers can alternately lie on top of each other to form a layered structure of the coil arrangement.

Excitation coil windings may be disposed inside and outside of the pickup coils.

In some embodiments, the orientation (clockwise or counterclockwise) of the generator coil windings is provided to vary. (E.g.: the coils inside the sensing coils run clockwise, with those outside running counterclockwise).

In some embodiments, a shaft is provided as the test object. In some embodiments, it is provided that a magnetic field conductor (defined as a material with a relative permeability >2, such as iron, ferrite, . . . ) is attached in the direction facing away from the test object, in particular facing away from the shaft. For example, the magnetic field conductor may be disc-shaped or arranged as a foil on the side facing away from the test object on the coil arrangement comprising excitation coil and measuring coils.

In some embodiments, it is provided that the magnetic field conductor pierces the inner diameter of at least one coil. Thus, if required, the at least one coil can be formed with a coil core for flux amplification.

In some embodiments, it is provided that a non-magnetic conductor is attached around the coil assembly or sensor head. This can be used to restrict the measuring range and attenuate radiation and irradiation of AC magnetic fields.

In some embodiments, it is provided that a magnetic field conductor having a diameter larger than the outer diameter of the magnetic field generating coil is used and is extended in the region outside the magnetic field generating coil towards the measuring object or test object.

In some embodiments, it is provided that the magnetic field conductor has at least one hole/recess through which the coil terminals can be passed.

In particularly preferred embodiments, the sensor head is constructed as shown in one of literatures [8] to [12], with the difference that at least the outermost turn of the excitation coil (also called generator coil or magnetic field generation coil there) is arranged radially outside the measuring coil arrangement. Radial and axial in this case refer to the center axis of the excitation coil, which preferably coincides with the center axis of the sensor head.

Exemplary embodiments are described in more detail below with reference to the accompanying drawings. In the drawings it is shown by:

### BRIEF DESCRIPTION OF THE DRAWINGS

FIG. 1 a plan view of the side of a sensor head to be turned to a test object for a load measuring device according to a first embodiment;

FIG. 2 a view as in FIG. 1, with coil windings of an excitation coil and of measuring coils of the sensor head schematically indicated;

FIG. 3 a plan view as in FIG. 1 of a sensor head according to a second embodiment;

FIG. 4 a schematic sectional view along an axial plane through a coil arrangement of the sensor head of FIG. 3, showing a plurality of excitation coil layers having windings of a planar coil forming part of the excitation coil and a plurality of measuring coil layers having windings of planar coils each forming part of individual measuring coils;

FIG. 5 a schematic view of an arrangement of an excitation coil layer and a measuring coil layer;

FIG. 6 a plan view as in FIG. 1 of a sensor head according to a third embodiment;

FIG. 7 a schematic view as in FIG. 2 of the sensor head according to the third embodiment;

FIG. 8 a schematic cross-sectional view of a load measuring arrangement with the test object and the schematically illustrated sensor head according to a fourth embodiment;

FIG. 9 a plan view of the side of a sensor head to be turned to the test object according to a fifth embodiment;

FIG. 10 a schematic cross-sectional view of the load measuring arrangement as in FIG. 8 with a sensor head according to a sixth embodiment.

### DETAILED DESCRIPTION

The drawings show different embodiments of a sensor head 10 for a load measuring device 12 for measuring a load in a test object 14 on the basis of load-dependent magnetic properties of the test object 14. The sensor head 10 comprises a magnetic field generating unit 16 for generating a magnetic field in the test object 14, and a magnetic field measuring unit 18 for measuring a magnetic field change in the test object 14. The magnetic field generating unit 16 comprises at least one excitation coil 20, 20a, 20i having a plurality of excitation coil windings 24, 24a, 24i arranged around an excitation coil axis 22. The magnetic field measuring unit 18 includes a measuring coil arrangement 26 having a plurality of measuring coils 28a-28d. The radially outermost excitation coil winding 24a is disposed radially outwardly of the measuring coil arrangement 26, as viewed with respect to the excitation coil axis 22. In other words, the measuring coil arrangement 26 is surrounded by at least the radially outermost excitation coil winding as viewed in an axial plan view of the sensor head 10, as can be seen in FIGS. 1-3, 6, 7 and 9.

FIGS. 1-3, 6 and 7 further show a load measuring device 12, which, in addition to the sensor head 10, shows a current source 30 connected to the at least one excitation coil 20 for supplying the magnetic field generating unit 16 with a periodically changing current and an evaluation device 32 connected to the measuring coils 28a-28d for generating a measuring signal from signals of the measuring coils 28a-28d. In FIGS. 8 and 10, a load measuring arrangement is still shown which, in addition to the load measuring device 12, also has the test object 14, for example a shaft on which a torque is to be measured.

The coils 20, 28a-28d can have different designs, examples of different coil designs can be found in literature [1] to [12]. In particular, in the first and third embodiments of the sensor head 10 discussed later, windings of the excitation coil(s) 20 and the measuring coils 28a-28d may lie on the same axial plane. The excitation coil windings may also be axially offset from the sensing coil windings.

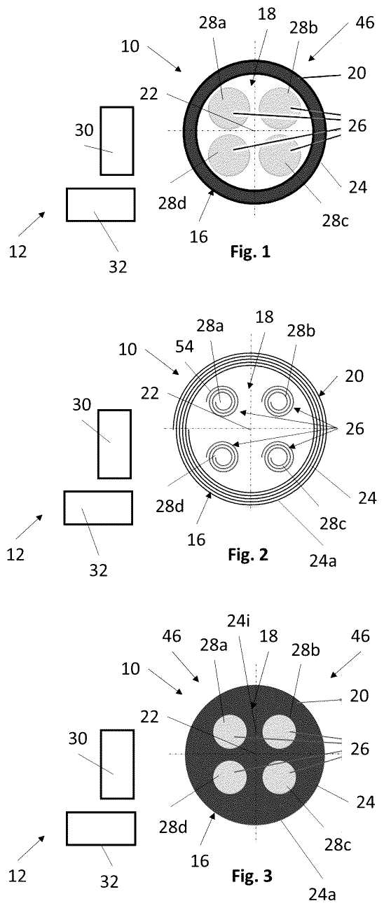

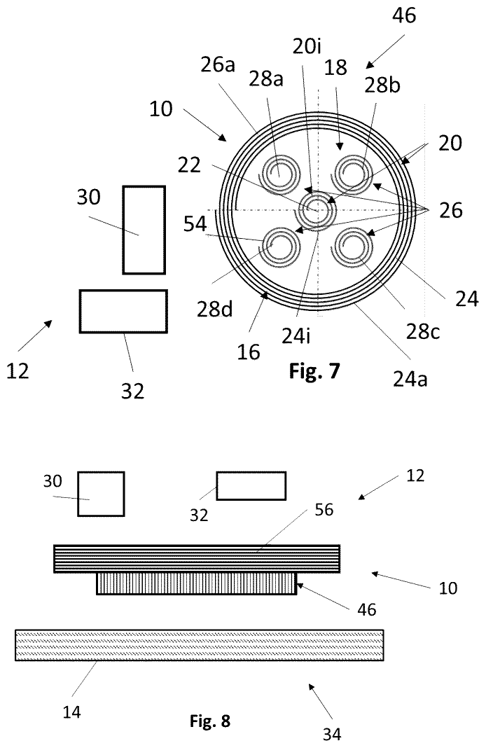

Preferably, in all preferred embodiments, the coils 20, 28a-28d are formed as multilayer planar coils 38 using PCB circuit board technology. In FIGS. 2 and 7, corresponding spiral windings of a planar coil layer are shown. Insulation material formed by PCB substrates and intermediate layers is provided for electrical insulation between those planar coil windings formed on printed circuit boards, which form the measuring coil windings 54 and the excitation coil windings 24. The windings together forming one of the coils 20, 28a-28d on different planar coil layers are interconnected by means of vias. Such a technique is known in principle, in particular, from literature [11] and [12], and therefore is not shown or described in detail.

The excitation coil 20, 20a, 20i formed by the different excitation coil windings 24, 24a, 24i is connected to the current source 30 so that the magnetic field is generated in the test object 14 by the periodic current and the previously non-magnetized test object 14 is actively magnetized during operation. Changes in the permeability of the material of the test object 14, which result from changes in voltages in the test object due to loads (force, torque, mechanical stress), are detected by means of the measuring coils 28a-28d, known as a four-pole sensor from [1] and [2], and evaluated by means of the evaluation device 32 connected thereto in order to output a signal indicating the load, which has a lower sensitivity to the distance to the test object compared to previous sensor heads or measuring sensors.

The features and differences of the embodiments shown in the Figures are discussed below.

In FIGS. 1 and 2, a first embodiment of the sensor head 10 as part of the load measuring device 12 is shown. Here, FIG. 1 shows a plan view of the side to be turned to the test object 14 (i.e., the lower side in the illustration of FIGS. 8 and 10), while FIG. 2 schematically shows an exemplary embodiment for excitation coil windings 24, 24a and for measuring coil windings 54. The measuring coil arrangement 26 including the first to fourth measuring coils 28a-28d is completely radially disposed within the excitation coil 20 formed with a larger inner diameter and outer diameter. In other words, as viewed in this axial plan view, the sensing coils 28a-28d are completely surrounded by the excitation coil 20. The excitation coil 20 is arranged outside the pickup coils, i.e. measuring coils 28a-28d.

FIG. 3 shows, in the corresponding view as in FIG. 1, a second embodiment of the sensor head 10, in which the excitation coil 20 has both excitation coil windings 20a that extend radially outside the measuring coils 28a-28d and excitation coil windings 20i that extend inside the measuring coils 28a-28d or at least overlap with them.

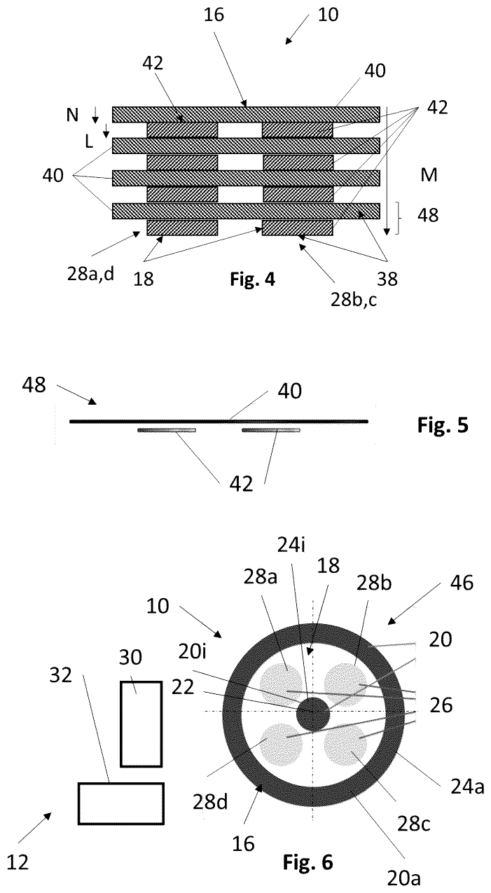

FIG. 4 shows an example of a layered structure 44 of the coil arrangement 26 comprising the excitation coil(s) and the measuring coil assembly 26 in schematic cross-section. The coils 20, 284-28d are constructed by the planar coils 38. In FIG. 5, a coil arrangement layer unit 48 comprising an excitation coil layer 40 having N layers of excitation coil spiral windings and a measuring coil layer 42 having layers of measuring coil spiral windings is shown alone. Each sensing coil layer 42 has spaced apart spiral windings in the radial plane for each of the measuring coils 28a-28d. M-fold repetition of the coil arrangement layer unit 48 results in the layered structure 46 of the coil arrangement 46. Due to the different axial positions of the excitation coil layers 40 and the measuring coil layers 42, the excitation coil windings 24, 24a, 24i may radially overlap with the measuring coil windings 54 or be superimposed one on another. In practice, the sensor head 10 has a sensor package known from [9] to [12] with intermediate layers for insulation and an envelope for encapsulation, but these are omitted in FIGS. 4 and 5 for reasons of presentation.

FIG. 3 shows a plan view of the sensor head 10 according to the second embodiment, with the measuring coils 28a-28d overlapped by the excitation coil 20. FIGS. 4 and 5 show the cross-section, from which it can be seen in which manner the sensing coils 28a-28d and the excitation coil 20 overlap.

FIGS. 6 and 7 show a third embodiment of the sensor head 10, wherein the magnetic field generating unit 16 also has, as in the second embodiment of FIG. 3, outer excitation coil windings 24a surrounding the measuring coil assembly 26 as seen in axial plan view, and inner excitation coil windings 24i arranged radially inside the sensing coils 28a-28d. In this case, an outer excitation coil 20a and an inner excitation coil 20i are provided. The structure of the coils 20, 28a-28d can again be arbitrary, preferably a layered structure 44 of multi-layered planar coils 38 is provided, in which case, too the windings of measuring coils 28a-28d and excitation coils 20 can share an axial plane—as in the first embodiment—and/or be axially offset from each other, as this is shown in FIGS. 4 and 5.

The inner excitation coil windings 24i and the outer excitation coil windings 24a may be wound in the same direction or may be wound in opposite directions. Accordingly, in some embodiments, the orientation (clockwise or counterclockwise) of the windings of the excitation coils 20, 20a, 20i is provided to vary. For example, the inner excitation coil windings 24i of the inner excitation coil 20i inside the measuring coils (=sensor coils) 28a-28d may be clockwise and the outer excitation coil windings 24a of the outer excitation coil, which are arranged radially outside the measuring coils 28a-28d, may be counterclockwise.

FIG. 8 shows an embodiment of the load measuring arrangement 34 with load measuring device 12 and a sensor head 10 in a fourth embodiment. The sensor head 10 has one of the coil arrangements 46 as shown in FIGS. 1 to 7 and used in the first to third embodiments. In addition, a magnetic field conductor 56 is provided on the side of the coil arrangement 46 to be turned away from the test object 14 (the side shown in FIG. 8 above). A magnetic field conductor 56 is a material having a relative permeability >2, such as iron or ferrite or . . . . The magnetic field conductor 56 is, for example, plate- or disk-shaped and/or formed such that it substantially covers (i.e., more than 50%, preferably more than 60%, in particular more than 90%) the side to be turned away from the test object 14. Preferably, the side is completely covered, optionally with the exception of holes/passage openings/recesses for contacting the coils. In the embodiment of FIG. 8, the diameter of the magnetic field conductor 56 is larger than that of the coil arrangement 46. The magnetic field conductor 56 protrudes laterally beyond the coil arrangement 46.

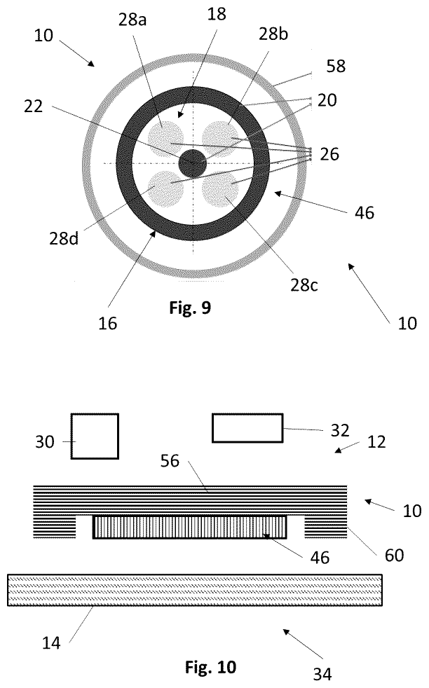

In FIG. 9, a fifth embodiment of the sensor head 10 is shown. In this embodiment, the coil arrangement 46 may optionally be formed with magnetic field conductor 56 as in any of the first through fourth embodiments. Additionally, a non-magnetic conductor 58 is further provided around the coil arrangement 46. For example, the sensor head 10 according to any of the first through fourth and sixth embodiments could be formed by a ring of non-magnetic (relative permeability <2) electrically conductive material, or such a sensor head 10 of the first through fourth and sixth embodiments is housed in an electrically conductive non-magnetic housing. The magnetic conductor 58 can be used to bound the measuring range, and radiation and irradiation of AC magnetic fields can be attenuated.

FIG. 10 shows, in a corresponding embodiment as in FIG. 8, still another sensor head 10 according to a sixth embodiment, which is formed similarly to the sensor head 10 of the fourth embodiment, using a magnetic field conductor 56 having a diameter larger than the outer diameter of the magnetic field generating excitation coil 20 and being extended in the region outside the magnetic field generating excitation coil 20 toward the test object 14. For example, the magnetic field conductor 56 has individual projections or an annular region, in this case formed as an annular collar 60, around the coil arrangement 46.

As is known in principle from [1] to [3], a magnetic field conductor for flux amplification may also be provided inside one or more of the individual coils 20, 20a, 20i, 28a-28d. For example, the magnetic field conductor 56 pierces the inner diameter of at least one coil 20, 28a-28d.

Preferably, the interconnection of the measuring coils 28a-28d and the evaluation are performed in the manner known from [10].

The various features of the different embodiments described may be combined with each other as desired, or may be omitted in other embodiments.

### LIST OF REFERENCE SIGNS

10 sensor head
12 load measuring device
14 test object
16 magnetic field generating unit
18 magnetic field measuring unit
20 excitation coil
20a outer excitation coil
20i inner excitation coil
22 excitation coil axis
24 excitation coil winding
24a outer excitation coil winding
24i inner excitation coil winding
26 measuring coil arrangement
28a first measuring coil
28b second measuring coil
28c third measuring coil
28d fourth measuring coil
30 current source
32 evaluation device
34 load measuring arrangement
38 planar coil
40 excitation coil layer
42 measuring coil layer
44 layer structure
46 coil arrangement
48 coil arrangement layer unit
50 excitation coil layer
54 measuring coil winding
56 magnetic field conductor
58 non-magnetic conductor
60 collar

What is claimed is:

1. A sensor head (10) for a load measuring device (12) for measuring a load in a test object (14) based on load-dependent magnetic properties of the test object (14), the sensor head (10) comprising:
a magnetic field generating unit (16) for generating a magnetic field in the test object (14); and
a magnetic field measuring unit (18) for measuring a magnetic field change in the test object (14),
wherein the magnetic field generating unit (16) comprises at least one excitation coil (20, 20a, 20i) having a plurality of excitation coil windings (24, 24a, 24i) arranged around an excitation coil axis (22), and
wherein the magnetic field measuring unit (18) comprises a measuring coil arrangement (26) having a plurality of measuring coils (281-28d), the radially outermost excitation coil winding (24a) being arranged radially outside the measuring coil arrangement (26), as seen with respect to the excitation coil axis (22), so that the measuring coil arrangement (26) is surrounded at least by the radially outermost excitation coil winding (24a), as seen in axial plan view of the sensor head (10).

2. The sensor head (10) according to claim 1, wherein the measuring coil arrangement (26) comprises:
2.1 a first to fourth measuring coil (28a-28d); and/or
2.2 measuring coils (28a-28d) arranged at the corners of an imaginary rectangle or square.

3. The sensor head (10) according to claim 1, wherein the measuring coils (28a-28d) and/or the at least one excitation coil (20, 20a, 20i) comprise at least one planar coil (38) or are designed as at least one such planar coil (38).

4. The sensor head (10) according to claim 1, wherein:
4.1 the measuring coil arrangement (26) is arranged radially inside all excitation coil windings (24) of the magnetic field generating unit (16) or
4.2 the magnetic field generating unit (16) has at least one outer excitation coil winding (24a) which runs radially outside the measuring coil arrangement (26) as well as at least one inner excitation coil winding (24i) which runs radially inside the measuring coil arrangement (26).

5. The sensor head (10) according to claim 4, wherein:
5.1 the at least one excitation coil (20, 20a, 20i) overlaps the measuring coil arrangement (26) or
5.2 an outer excitation coil (20a) is arranged radially outside the measuring coil arrangement (26) and an inner excitation coil (20i) is arranged radially inside the measuring coil arrangement (26) or
5.3 the orientation of the at least one outer excitation coil winding (24a) is opposite to the orientation of the at least one inner excitation coil winding (24i).

6. The sensor head (10) according to claim 1, wherein a magnetic field conductor (56) is provided on a side of the coil arrangement (46) formed by the at least one excitation coil (20, 20a, 20i) and the measuring coil arrangement (26) to be turned away from the test object (14).

7. The sensor head (10) according to claim 6, wherein:
7.1 the magnetic field conductor (56) pierces the inner diameter of at least one coil (20, 20a, 20i, 28a-28d) of the coil arrangement (46) and/or
7.2 the magnetic field conductor (56) covers the side of the coil arrangement (46) to be turned away from the test object (14) and/or
7.3 the magnetic field conductor (56) has a diameter larger than the diameter of the coil arrangement (46) and/or
7.4 the magnetic field conductor (56) projects in a region radially outside the coil arrangement (46) in the direction of the test object (14) and/or
7.5 the magnetic field conductor (56) has an annular region (60) which is arranged around the coil arrangement (46);
7.6 the magnetic field conductor (56) has one or more through-holes for passing through coil terminals.

8. The sensor head (10) according to claim 1, wherein a non-magnetic electrical conductor (58) surrounds the coil arrangement (46) or the coil arrangement (46) and the magnetic field conductor (56).

9. A load measuring device (12) for measuring a load in a test object (14), comprising:
the sensor head (10) according to claim 1;
a current source (30) connected to the at least one excitation coil (20, 20a, 20i) for supplying the magnetic field generating unit (16) with a periodically changing current; and
an evaluation device (32) connected to the measuring coils (28a-28d) for generating a measuring signal from signals of the measuring coils (28a-28d).

10. A load measuring arrangement (34) comprising the load measuring device (12) according to claim 9 and the test object (14).
